(19) United States
(12) Patent Application Publication
(10) Pub. No.: US 2024/0219343 A1
(43) Pub. Date: Jul. 4, 2024

(54) BACK GATE ION-SENSITIVE FIELD EFFECT TRANSISTOR SENSING WITH STACKED HIGH-K NANOSHEETS

(71) Applicant: GlobalFoundries Singapore Pte. Ltd., Singapore (SG)

(72) Inventors: Chia Ching Yeo, Singapore (SG); Khee Yong Lim, Singapore (SG); Kiok Boone Elgin Quek, Singapore (SG)

(21) Appl. No.: 18/149,200

(22) Filed: Jan. 3, 2023

(51) Int. Cl. G01N 27/414

(52) U.S. Cl. CPC G01N 27/4146; G01N 27/4148

(57) ABSTRACT

A device for analyte sensing and method of forming the device. The device includes a first semiconductor layer including a source region, a drain region and a stack of semiconductor nanosheets extending between the source region and the drain region; a first dielectric layer on the semiconductor layer; and a cavity extending through the first dielectric layer and the first semiconductor layer. The semiconductor nanosheets are disposed within the cavity, and a portion of the cavity resides in between the semiconductor nanosheets.

### BACKGROUND

### Field of the Invention

The present invention relates to semiconductor structures and, more particularly, to an ion-sensitive field effect transistor (ISFET) device having stacked high dielectric constant (high-k) nanosheets for sensing properties of an analyte solution.

### Related Art

Sensors based on ion-sensitive field effect transistors (ISFETs) can be integrated into chip manufacturing processes and can be used to detect and measure various aspects of chemical reactions and substance properties. For example, an ISFET may be used as a sensor in an integrated circuit to measure ion concentrations, such as hydrogen ion concentration, in a sample of an analyte solution.

### SUMMARY

Aspects of the disclosure include a device for analyte sensing, the device including: a first semiconductor layer including a source region, a drain region and a stack of semiconductor nanosheets extending between the source region and the drain region; a first dielectric layer on the semiconductor layer; and a cavity extending through the first dielectric layer and the first semiconductor layer, wherein the semiconductor nanosheets are disposed within the cavity, and a portion of the cavity resides in between the semiconductor nanosheets.

Aspects of the disclosure further include a method of fabricating an ion sensitive field effect transistor (ISFET), including: forming a fin pattern on a silicon on insulator (SOI) substrate; forming a set of silicon germanium/silicon (SiGe/Si) layers on a central portion of the fin pattern; epitaxially growing doped silicon above the outer portions of the fin pattern to form source and drain regions; forming silicon (Si) layers from the SiGe/Si layers; forming a high dielectric constant (high-k) film on the silicon layers; and forming a dielectric layer above the source and drain regions.

Aspects of the disclosure further include a method of fabricating an ion sensitive field effect transistor (ISFET), including: etching a fin pattern on a silicon on insulator (SOI) substrate having a buried oxide (BOX) layer disposed therein; epitaxially growing a set of silicon germanium/silicon (SiGe/Si) layers on the fin pattern; wrapping a central portion of the SiGe/Si layers with a dielectric; removing SiGe/Si layers above the outer portions of the fin pattern; epitaxially growing doped silicon above the outer portions of the fin pattern to form source and drain regions; removing the dielectric and wet etching the SiGe from the central portion of the SiGe/Si layers; depositing a high-k film on the silicon and removing the high-k film from the source and drain regions; and forming a dielectric layer above the source and drain regions.

A further aspect includes an analyte sensor device, including: a first semiconductor layer including a source region, a drain region and a stack of semiconductor nanosheets extending between the source region and the drain region; a first dielectric layer on the semiconductor layer; a cavity extending through the first dielectric layer and the first semiconductor layer, wherein the semiconductor nanosheets are disposed within the cavity, and a portion of the cavity resides in between the semiconductor nanosheets; and a back gate structure defined by a second dielectric layer and a second semiconductor layer disposed beneath the first semiconductor layer, the back gate structure, source region and drain region each including a metal contact.

Two or more aspects described in this disclosure, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The present invention will be better understood from the following detailed description with reference to the drawings, which are not necessarily drawn to scale. In the drawings, like reference numerals refer to like features in the various views.

FIG. 1 depicts a semiconductor device for an ion-sensitive field effect transistor (ISFET) sensor in accordance with embodiments of the disclosure.

FIGS. 2-10 depict an illustrative process for forming an ISFET according to embodiments of the disclosure.

FIG. 11 depicts an alternative embodiment of a semiconductor device for an ISFET sensor according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

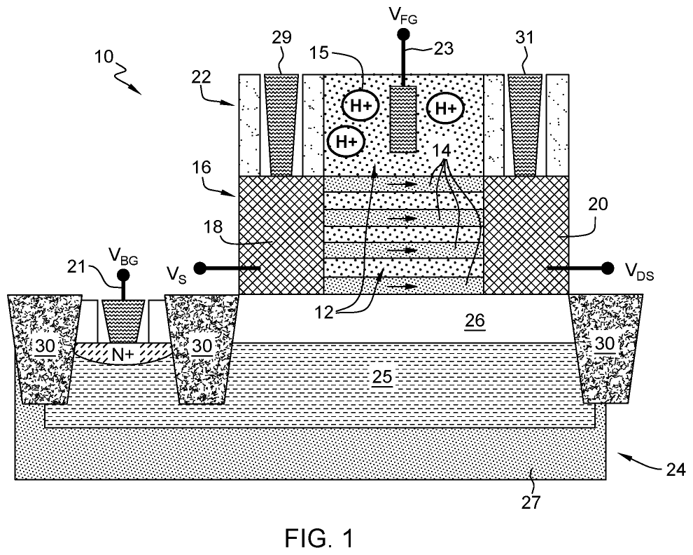

With reference to FIG. 1, and in accordance with embodiments of the disclosure, an illustrative device 10 for an ion-sensitive field effect transistor (ISFET) sensor is shown, which can be formed on a wafer such as a semiconductor-on-insulator (SOI) wafer. The device 10 includes a cavity 12 formed between a source region 18 and drain region 20 that is configured to receive an analyte 15. Cavity 12 includes a plurality of stacked nanosheets 14 that span across a channel region of the cavity 12 and can contact the analyte 15 along, e.g., the top, bottom and/or side surfaces of the nanosheets 14. Accordingly, a portion of cavity 12 that receives the analyte resides in between the nanosheets 14. Cavity 12 also include a front gate terminal 23 (V_{FG}) disposed therein.

In various embodiments, each nanosheet 14 includes a high dielectric constant (high-k) material, e.g., a deposited film of hafnium dioxide (HfO₂), aluminum oxide (Al₂O₃), hafnium aluminum oxide (HfAlO), etc., that acts as a sensing membrane, capable of interacting with H+ ions of the analyte to sense properties such as acidity (pH) levels. The term high-k generally refers to materials with a high dielectric constant as compared to silicon dioxide. In utilizing such a film, the potential of the channel between the source region 18 and drain region 20 is modulated based on the amount of H⁺ ion bonding with the sensing membrane. The change in potential results in a measurable current change that is, e.g., related to the pH in the analyte.

In this illustrative embodiment, device 10 includes an ultrathin silicon on insulator (UTSOI) substrate 24 that includes a Psub region 27 and an Nwell region 25, and a buried oxide (BOX) layer 26 formed thereon in between shallow trench isolation (STI) regions 30. An epitaxially grown semiconductor layer 16 (e.g., Si) is formed above the BOX layer 26 and includes an N+ implanted source region 18 and an N+ implanted drain region 20. (Note that while this example shows a p-type device, it is understood that a similar n-type device could alternatively be fabricated with the same principles.) A dielectric layer 22 (e.g., SiN) is formed above the semiconductor layer 16, and cavity 12 is formed within the layers 16, 22. The stack of semiconductor nanosheets 14 (i.e., semiconductor multi-sheets) are formed with the same material as semiconductor layer 16 (e.g., Si) between the source region 18 and drain region 20 of semiconductor layer 16.

Source and drain regions 18, 20 further include metallic contacts 29 and 31. A dielectric, e.g., BOX layer 26, is accordingly disposed between a first semiconductor layer 16 and a second (i.e., UTSOI) semiconductor layer 24 and BOX layer 26 and the second semiconductor layer 24 defines a back gate structure that includes a metallic back gate contact 21 (V_{BG}).

In the case of a p-type FET device, electrons flow through each nanosheet 14 as shown by the arrows from the source region 18 to the drain region 20. As noted, each nanosheet is coated with a high-k film that acts as a sensor membrane to interact with the H+ ions in the analyte 15 and modulate the potential of the channel region between the source and drain regions 18, 20.

In this embodiment, the surface potential change of the nanosheets 14 is detected by the back gate contact 21 in second semiconductor layer 24 through capacitive coupling. In one approach for detecting the potential change, V_{FG} and V_{S} are set to ground, and V_{DS} is biased at 0.1V. V_{BG} is swept (i.e., ramps between two values) and a threshold voltage Vth for the analyte is recorded. For an NFET, V_{BG} is swept in a positive direction, and Vth is V_{BG} at a fixed I_{DS} current. This fixed I_{DS} current is typically Ic*W/L, where Ic is for example about 300 nano-Amperes (nA), and W and L are the width and length of the channel (into/out of the page and across the page of the drawing). Vth is obtained when the cavity 12 is filled with analyte 15, which is then compared to a control sample and a ΔVth is calculated. The pH value of the analyte may be determined through a lookup table based on the ΔVth value, e.g., based on empirical data. For a PFET, ΔVth is calculated similarly except V_{BG} will be swept in a negative direction.

At a fixed drain to source current I_{DS}, the change (i.e., Δ) in Vth at the back gate Vth_{BG} that is required to compensate for the change (i.e., A) in Vth_{FG} resulting by a change in the sensor membrane potential can be calculated as follow:

$$Δ {V th}_{BG} = ( {C}_{FG} / {C}_{BOX} ) * ( ( {C}_{si} + {C}_{BOX} ) / ( α * {C}_{si} ) ) * Δ {V th}_{FG}$$

in which C_{FG}, C_{BOX} and Cₛᵢ are the fluid gate capacitance, back gate capacitance of BOX 26, and silicon (Si) depletion capacitance per unit area, and a is a correction factor. From this equation, it can be deduced that the higher the value of C_{FG}, the higher the ΔVth_{BG}. This structure thus provides a higher sensitivity to pH level changes in the analyte 15.

In various aspects, BOX layer 26 may have a thickness of between about 10-20 nanometers (nm), and each nanosheet 14 may have a thickness of between about 5-20 nm. The space between each nanosheet 14 may likewise be about 5-20 nm. In the depicted embodiment, four nanosheets 14 are shown (three of which have exposed top and bottom surface and one has just the top exposed); however, it is understood that the size and number of nanosheets 14 could be greater or less, e.g., depending on the requirements of the sensor.

As is evident, the use of a stacked layer of nanosheets 14 allows for a large amount of surface area for exposure to the analyte, which allows for increased H+ ion bonding. This increases sensitivity and signal-to-noise ratio without having to increase the pitch size of the device.

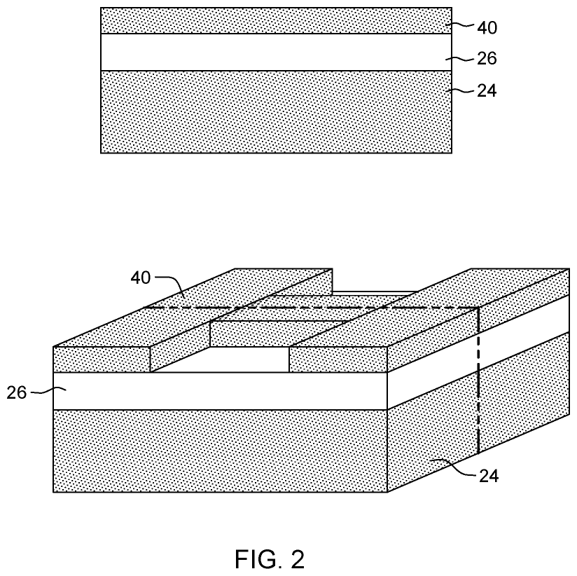

FIGS. 2-10 depict an illustrative process for fabricating the nanosheet structure similar to that shown in FIG. 1. FIGS. 2-9 each include two views of various process steps, anisometric view on the bottom of the page and a cross-sectional view sliced through the center of the device 10 along the dashed line shown in FIG. 2 at the top of the page. It is understood that the process described herein is intended to provide an illustrative technique for fabricating device 10, and other approaches and structures could likewise be used. Furthermore, it is understood that the particular materials described here are likewise for illustrative purposes only and are not intended to be limiting.

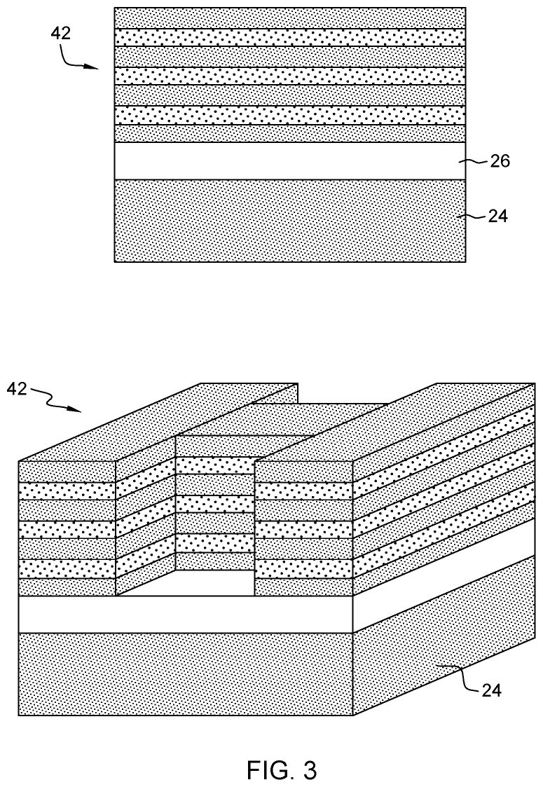

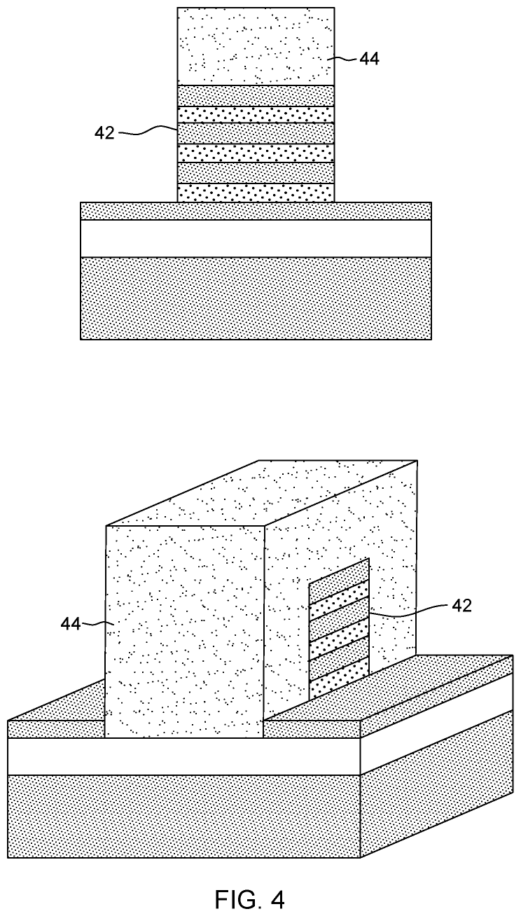

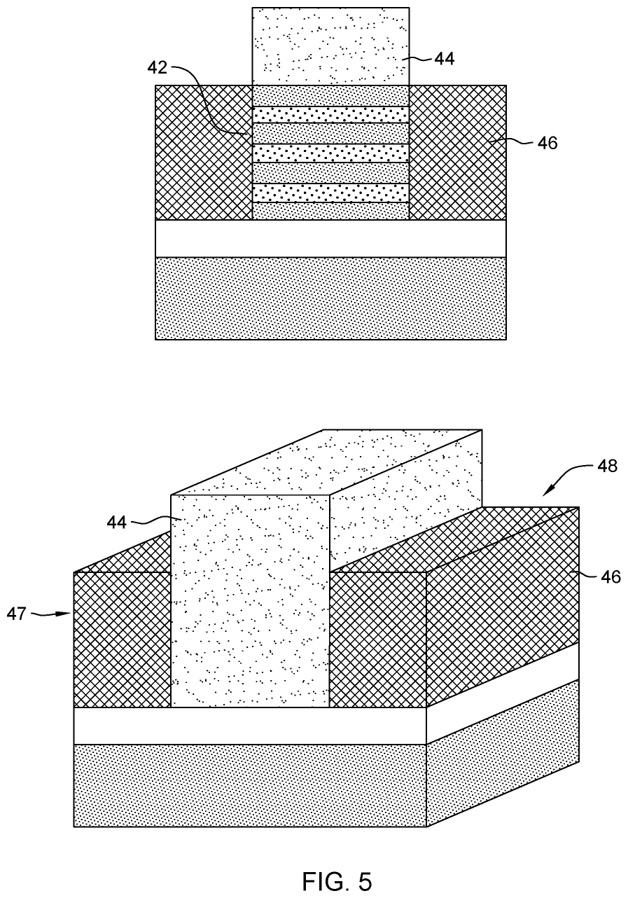

As shown in FIG. 2, the process begins with an ultra-thin SOI (UTSOI) substrate 24 having a BOX layer 26. A top portion of UTSOI substrate 24 (above the BOX layer 26) is etched as shown in the bottom diagram in a fin pattern that forms a bottom layer 40 of a nanosheet stack. In this example, the fin pattern is an H-shaped pattern that includes a central portion and two outer portions. Next, as shown in FIG. 3, alternating layers of SiGe/Si are epitaxially grown above the bottom layer 40 maintaining the fin pattern, in this case a SiGe/Si/SiGe/Si/SiGe/Si stack 42 is grown. The number of SiGe/Si layers in the stack depends on the number of nanosheets required. Next, as shown in FIG. 4, a SiN region 44 is formed using hard mask patterning and deposition that wraps around the stack 42. This is followed by stacked Si nanolayer fins patterning to remove some of the stack 42 above the outer portions of the fin pattern, leaving just the central portion of the stack 42. Next, as shown in FIG. 5, doped Si regions 46 are epitaxially grown above the outer portions of the fin pattern adjacent the SiN region 44 to form the source and drain regions 47, 48. Alternatively, Si 46 regions could be implanted to form source and drain regions 47, 48 adjacent the sides of the stack 42.

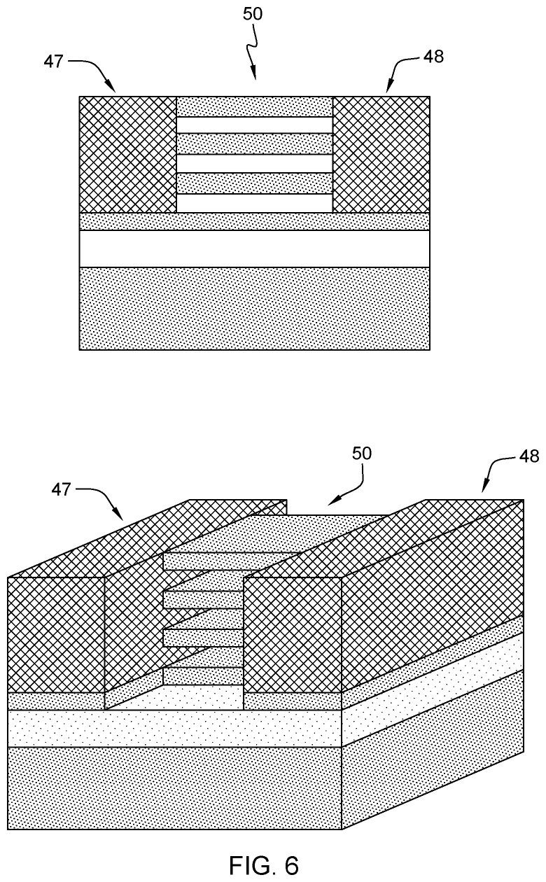

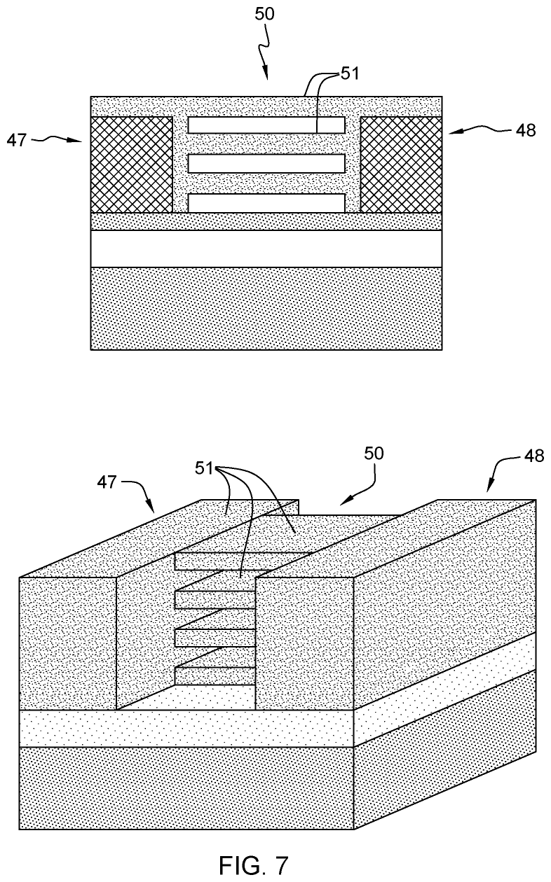

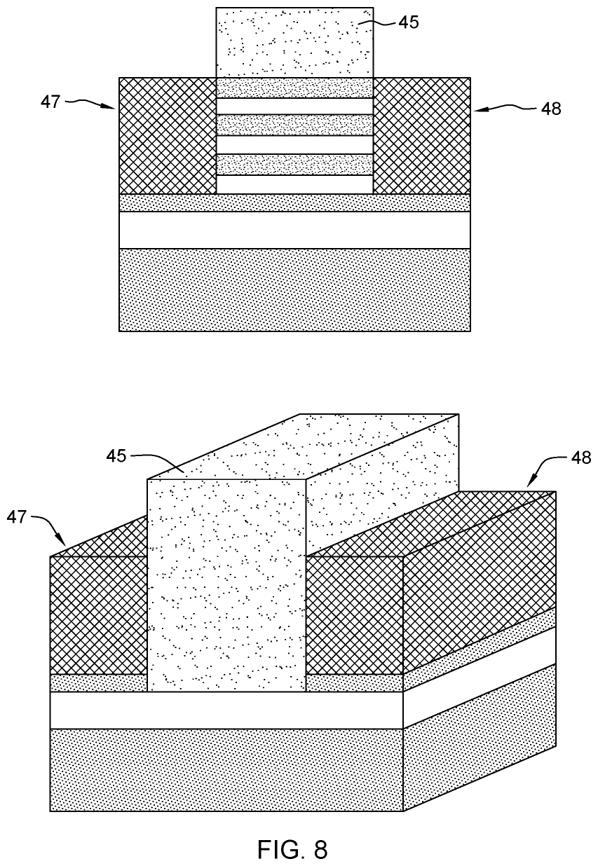

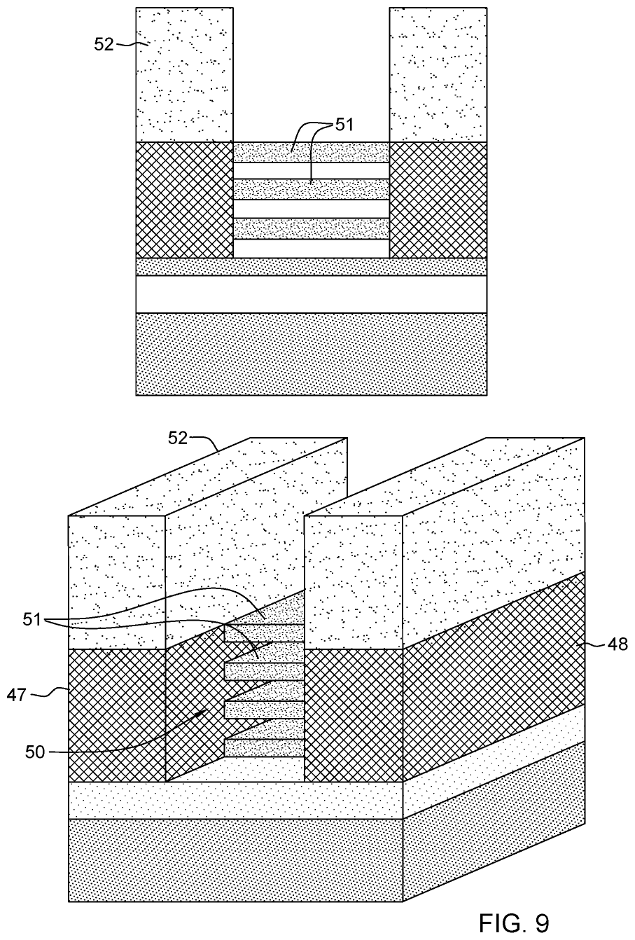

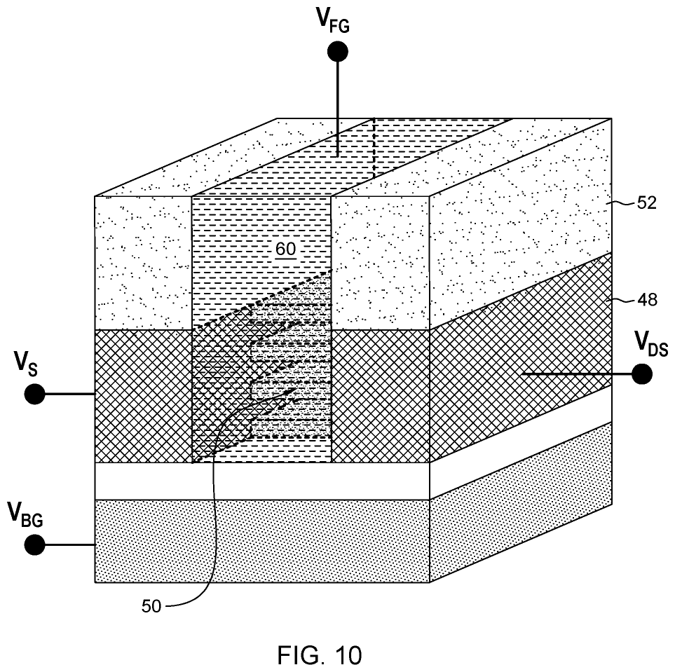

Next, as shown in FIG. 6, SiN hard mask removal occurs, followed by wet etch to remove the SiGe layers to reveal the stacked nanosheets 50. At FIG. 7, atomic layer deposition (ALD) of a high-k film 51 is applied to form sensor membranes on the nanosheets 50 (as well as source and drain regions 47, 48). Next, as shown in FIG. 8, the nanosheets 50 are masked with a photoresist (PR) mask 45 and the high-k deposits 51 are removed from the source and drain regions 47, 48. At FIG. 9, the PR mask is removed and a dielectric layer 52, e.g., SiN passivation layer, is deposited above the outer portions of the fin pattern, followed by contact and metal line scheme definitions. Finally, as shown in FIG. 10, individual terminals for V_{DS}, V_{S} and V_{BG} are accessed through the passivation layer 52 by an etching step. As the process to form such terminals are well known in the art, the details are omitted so the reader can focus on the relevant features of the disclosure. The resulting structure is accordingly configured to receive an analyte 60. Note that the isolation process for the silicon nanosheet sensor membrane cell is not shown in the process flow.

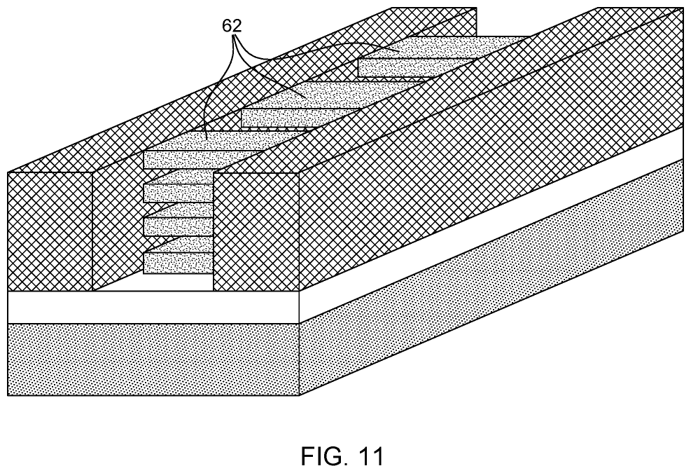

FIG. 11 depicts an alternative embodiment in which multiple separated nanosheet stacks 62 are fabricated within a single structure. Note that the SiN layer is not shown to better illustrate multiple stacks 62 but would be included in the actual structure.

It should be understood that in the structures and methods described above, a semiconductor material refers to a material whose conducting properties can be altered by doping with an impurity. Exemplary semiconductor materials include, for example, silicon or germanium-based semiconductor materials (e.g., silicon, silicon germanium, silicon germanium carbide, silicon carbide, etc.) and III-V compound semiconductors (i.e., compounds obtained by combining group III elements, such as aluminum (Al), gallium (Ga), or indium (In), with group V elements, such as nitrogen (N), phosphorous (P), arsenic (As) or antimony (Sb)) (e.g., GaN, InP, GaAs, or GaP). A pure semiconductor material and, more particularly, a semiconductor material that is not doped with an impurity for the purposes of increasing conductivity (i.e., an undoped semiconductor material) is referred to in the art as an intrinsic semiconductor. A semiconductor material that is doped with an impurity for the purposes of increasing conductivity (i.e., a doped semiconductor material) is referred to in the art as an extrinsic semiconductor and will be more conductive than an intrinsic semiconductor made of the same base material. That is, extrinsic silicon will be more conductive than intrinsic silicon; extrinsic silicon germanium will be more conductive than intrinsic silicon germanium; and so on.

Furthermore, it should be understood that different impurities (i.e., different dopants) can be used to achieve different conductivity types (e.g., P-type conductivity and N-type conductivity) and that the dopants may vary depending upon the different semiconductor materials used. For example, a silicon or germanium-based semiconductor material (e.g., silicon, silicon germanium, silicon germanium carbide, silicon carbide, etc.) is typically doped with a Group III dopant, such as boron (B) or indium (In), to achieve P-type conductivity, whereas such a semiconductor material is typically doped with a Group V dopant, such as arsenic (As), phosphorous (P) or antimony (Sb), to achieve N-type conductivity. A gallium nitride (GaN)-based semiconductor material is typically doped with magnesium (Mg) to achieve P-type conductivity and with silicon (Si) or oxygen to achieve N-type conductivity. Those skilled in the art will also recognize that different conductivity levels will depend upon the relative concentration levels of the dopant(s) in a given semiconductor region. Furthermore, when a semiconductor region or layer is described as being at a higher conductivity level than another semiconductor region or layer, it is more conductive (less resistive) than the other semiconductor region or layer; whereas, when a semiconductor region or layer is described as being at a lower conductivity level than another semiconductor region or layer, it is less conductive (more resistive) than that other semiconductor region or layer.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should be understood that the terminology used herein is for the purpose of describing the disclosed structures and methods and is not intended to be limiting. For example, as used herein, the singular forms “a”, “an” and “the” are intended to include the plural forms as well, unless the context clearly indicates otherwise. Additionally, as used herein, the terms “comprises” “comprising”, “includes” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right”, “left”, “vertical”, “horizontal”, “top”, “bottom”, “upper”, “lower”, “under”, “below”, “underlying”, “over”, “overlying”, “parallel”, “perpendicular”, etc., are intended to describe relative locations as they are oriented and illustrated in the drawings (unless otherwise indicated) and terms such as “touching”, “in direct contact”, “abutting”, “directly adjacent to”, “immediately adjacent to”, etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings.

References herein to terms modified by language of approximation, such as “about”, “approximately”, and “substantially”, are not to be limited to the precise value specified. The language of approximation may correspond to the precision of an instrument used to measure the value and, unless otherwise dependent on the precision of the instrument, may indicate +/−10% of the stated value(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction perpendicular to the horizontal, as just defined. The term “lateral” refers to a direction within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “in direct contact with” another feature if intervening features are absent. A feature may be “indirectly on” or “in indirect contact with” another feature if at least one intervening feature is present.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device for analyte sensing, the device comprising:
a first semiconductor layer including a source region, a drain region and a stack of semiconductor nanosheets extending between the source region and the drain region;
a first dielectric layer on the semiconductor layer; and
a cavity extending through the first dielectric layer and the first semiconductor layer, wherein the semiconductor nanosheets are disposed within the cavity, and a portion of the cavity resides in between the semiconductor nanosheets.

2. The device of claim 1, wherein the semiconductor nanosheets includes a high dielectric constant (high-k) material.

3. The device of claim 2, wherein the high-k material is applied to a plurality of surfaces of the semiconductor nanosheets.

4. The device of claim 2, wherein the high-k material includes one of hafnium dioxide (HfO₂), aluminum oxide (Al₂O₃), or hafnium aluminum oxide (HfAlO).

5. The device of claim 1, wherein the cavity is configured to hold an analyte.

6. The device of claim 5, wherein the device comprises and ion sensitive field effect transistor (ISFET).

7. The device of claim 1, wherein the source region and drain region each include a metallic contact.

8. The device of claim 1, further comprising a second dielectric layer beneath the first semiconductor layer and a second semiconductor layer beneath the second dielectric layer, the second dielectric layer and the second semiconductor layer defining a back gate structure.

9. The device of claim 8, wherein the back gate structure includes a metallic contact.

10. The device of claim 1, further comprising a plurality of separated semiconductor nanosheet stacks within the cavity and extending between the source region and the drain region.

11. A method of fabricating an ion sensitive field effect transistor (ISFET), comprising:
forming a fin pattern on a silicon on insulator (SOI) substrate;
forming a set of silicon germanium/silicon (SiGe/Si) layers on a central portion of the fin pattern;
epitaxially growing doped silicon above the outer portions of the fin pattern to form source and drain regions;
forming silicon (Si) layers from the SiGe/Si layers;
forming a high dielectric constant (high-k) film on the silicon layers; and
forming a dielectric layer above the source and drain regions.

12. The method of claim 11, wherein the dielectric layer comprises silicon nitride (SiN).

13. The method of claim 11, wherein the fin pattern comprises an H-shaped pattern.

14. The method of claim 11, further comprising forming terminals for a source region, drain region, and back gate region.

15. An analyte sensor device, comprising:
a semiconductor layer including a source region, a drain region and a stack of semiconductor nanosheets extending between the source region and the drain region;
a first dielectric layer on the semiconductor layer;
a cavity extending through the first dielectric layer and the first semiconductor layer, wherein the semiconductor nanosheets are disposed within the cavity, and a portion of the cavity resides in between the semiconductor nanosheets; and
a back gate structure defined by a second dielectric layer and a second semiconductor layer disposed beneath the first semiconductor layer, wherein the back gate structure, the source region and the drain region each include a metallic contact.

16. The device of claim 15, wherein the semiconductor nanosheets includes a high dielectric constant (high-k) material.

17. The device of claim 16, wherein the high-k material includes one of hafnium dioxide (HfO₂), aluminum oxide (Al₂O₃), or hafnium aluminum oxide (HfAlO).

18. The device of claim 17, wherein the cavity is configured to hold an analyte.

19. The device of claim 18, wherein sensing a property of the analyte is implemented by:
setting a source voltage V_{S} to ground;
biasing a drain/source voltage V_{DS} to approximately 0.1 V; and
sweeping a back gate voltage V_{BG} and recording a threshold voltage Vth at the back gate structure.

20. The device of claim 19, wherein the back gate voltage V_{BG} is swept positively for an NFET and negatively for a PFET.
